(19) United States
(12) Patent Application Publication
(10) Pub. No.: US 2007/0249975 A1
(43) Pub. Date: Oct. 25, 2007

(54) Portable ball-containing massage device

(76) Inventors: Cheng-Kuei Pan, Taipei County (TW); Tang-Min Lan, Taoyuan County (TW)

Correspondence Address: BIRCH STEWART KOLASCH & BIRCH, PO BOX 747, FALLS CHURCH, VA, 22040-0747, US

(21) Appl. No.: 11/406,314

(22) Filed: Apr. 19, 2006

(51) Int. Cl. A61H 15/00

(52) U.S. Cl. 601/118; 601/113; 601/123

(57) ABSTRACT

The present invention discloses a portable ball-containing massage device, which comprises: multiple balls and a body. The body has at least one accommodation surface, which those balls are installed to and can rotate within. Multiple retainers are installed between the accommodation surface and the balls and used to accommodate the balls. The curvature of the accommodation surface and the sizes of the balls may vary to match some portion of the human body. The body may be a base with a handle, a column with a slip-proof element, or a fabric, which can separately provide a holding function or a large-area massage effect for the user.

### BACKGROUND OF THE INVENTION

1. Field of the Invention

The present invention relates to a massage device, particularly to a portable ball-containing massage device with multiple balls installed thereon.

2. Description of the Related Art

When one is massaged, the skin and the muscle are rubbed with the palms or pinched with the fingers so as to improve blood circulation and relax tension. A massage device may take the place of the hands, and it is often roller-like. A Taiwan patent of publication No. 595472—“Improved Rod-Like Magnetic Massage Device”—_also proposes a rod-like massage device. The conventional massage device has a rod-like external cylinder, and both ends thereof respectively have tapered openings. The cylinder is divided into two accommodation chambers by a separator. One of the accommodation chambers has a spring, and the front end of the spring presses against a magnet with a spherical concave. A massage ball is installed between the spherical concave of the magnet and the tapered opening of the external cylinder, and a portion of the spherical surface of the ball protrudes from the tapered opening. The other accommodation chamber of the external cylinder also has a magnet, and a block with multiple massage bars is installed between the magnet and the tapered opening of the external cylinder, and the massage bars protrude from the tapered opening of the external cylinder.

Besides the abovementioned “Rod-Like Magnetic Massage Device”, which has only one massage ball at one end thereof, a Taiwan patent of license No. M284382 discloses a “Ball-containing Massage Rod” with two massage balls installed to both ends thereof. The conventional massage rod has a holding body, and both ends of the holding body respectively have massage portions. Those two massage portions respectively have a large press-fit socket and a small press-fit socket. Each press-fit socket has an external press-fit ring and an internal press-fit ring. The massage ball is press-fitted to the press-fit socket. Both the external press-fit ring and the internal press-fit ring press against the massage ball, but the massage ball can roll freely therein to perform a massage action. A PRC patent of application No. 98248889.0 also discloses a “Ball-containing Massage Rod”. The conventional massage device has a handle, an installing base, and an installing head. The installing base has a U-shape runner, and the installing head is plate-like and has a central arch. The middle of the arch has three hemispherical ball sockets, which have central openings and protrude outward. The installing head is installed inside the U-shape runner of the installing base, and one portion of the ball protrudes from the ball socket. Another portion of the ball cooperates with the U-shape runner to rotate. The related patents may also refer to U.S. Pat. No. 5,637,065, No. 5,935,089, No. 5,868,689, and No. 4,554,911, and the PRC patent of application No. 92238671.4, and so on.

In view of the abovementioned prior arts, it is known that the conventional massage devices cannot afford a large-area massage the user desires but can only work on a point or a small area at one time.

### SUMMARY OF THE INVENTION

The primary objective of the present invention is to expand massage effect from point to plane via providing a portable ball-containing massage device, which comprises: multiple balls and a body, wherein the material of the balls is selected from the group consisting of metal, magnet, stone, wood and plastic; the body has at least one accommodation surface, which the balls are installed to and can rotate within; and multiple retainers are installed between the accommodation surface and the balls.

Further, the curvature of the accommodation surface and the sizes of the balls may vary to match some portion of the human body. The body may be a base with a handle, a column with a slip-proof element, or a fabric, which can separately provide a holding function or a large-area massage effect for the user.

### BRIEF DESCRIPTION OF THE DRAWINGS

FIG. 1 is an appearance perspective view according to one embodiment of the present invention.

FIG. 2 is a sectional view according to one embodiment of the present invention.

FIG. 3 is a diagram schematically showing another embodiment of the present invention.

FIG. 4 is a diagram schematically showing yet another embodiment of the present invention.

FIG. 5 is a diagram schematically showing still another embodiment of the present invention.

FIG. 6 is a diagram schematically showing further another embodiment of the present invention.

### DETAILED DESCRIPTION OF THE INVENTION

The technical contents of the present invention are to be described in cooperation with drawings below.

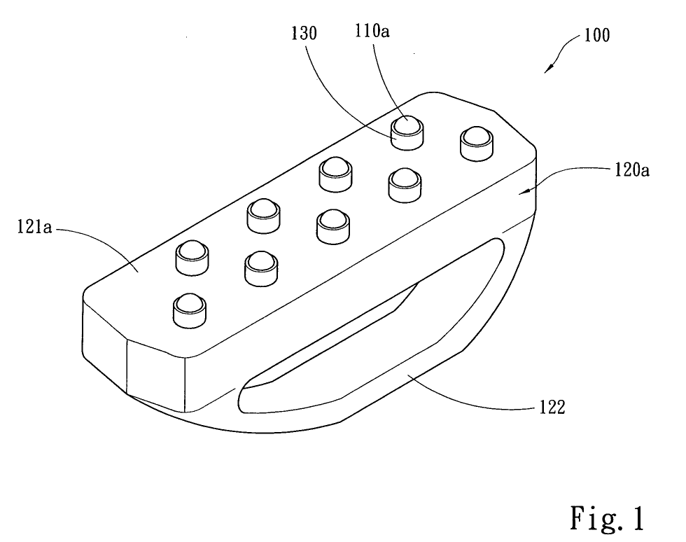

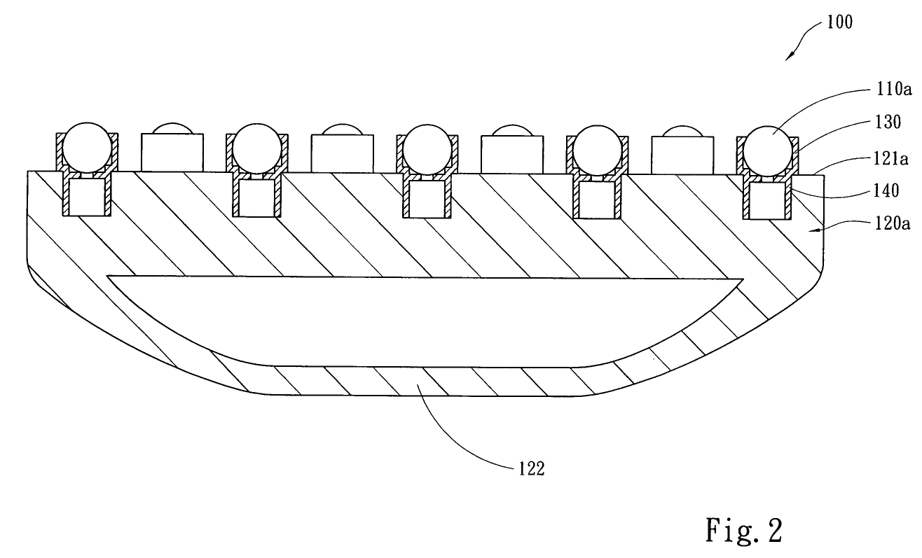

Refer to FIG. 1 and FIG. 2 respectively an appearance perspective view and a sectional view according to one embodiment of the present invention. According to this embodiment, the portable ball-containing massage device 100 comprises: multiple balls 110a and a body. The material of the balls 110a is selected from the group consisting of metal, magnet, stone, wood and plastic. The body may be a base 120a with a handle 122 for user's grasp. The base 120a may be a one-piece part. The base 120a has an accommodation surface 121a and multiple installing sockets 140 disposed on the accommodation surface 121a. Multiple retainers 130, inside which the balls 110a are accommodated and can rotate, are installed between the accommodation surface 121a and the balls 110a. The balls 110a are respectively embedded in the accommodation spaces inside the retainers 130. A portion of each ball 110a protrudes outward from the accommodation space, and each ball 110a can rotate freely within the accommodation space but is confined to the accommodation space by the retainer 130. When the user presses the accommodation surface 121a with the balls 110a against his skin and pushes/pulls the portable ball-containing massage device 100 back and forth on his skin, the balls 110a are driven to roll within the retainers 130 by the friction force between his skin and the balls 110a.

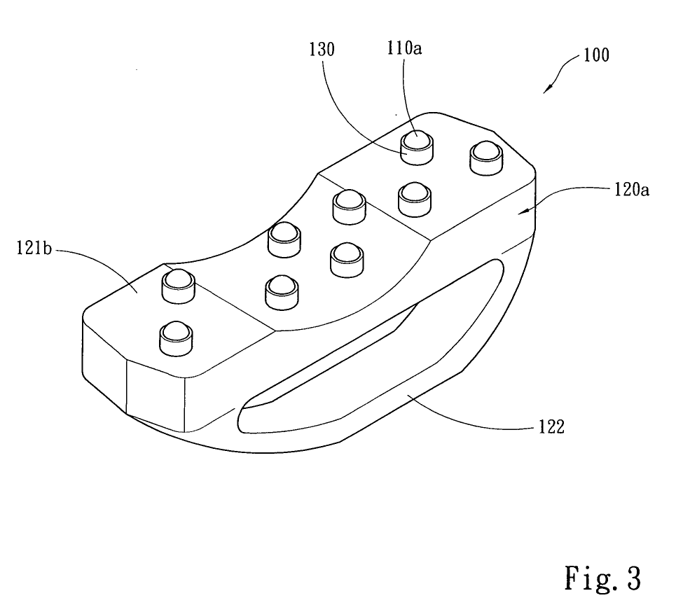

Refer to FIG. 3 a diagram schematically showing another embodiment of the present invention. According to this embodiment, the curvature of an accommodation surface 121b may vary to match some portion of the human body. As shown in FIG. 3, the central portion of the accommodation surface 121b is slightly concaved to match the contour of the wrist or the shoulder.

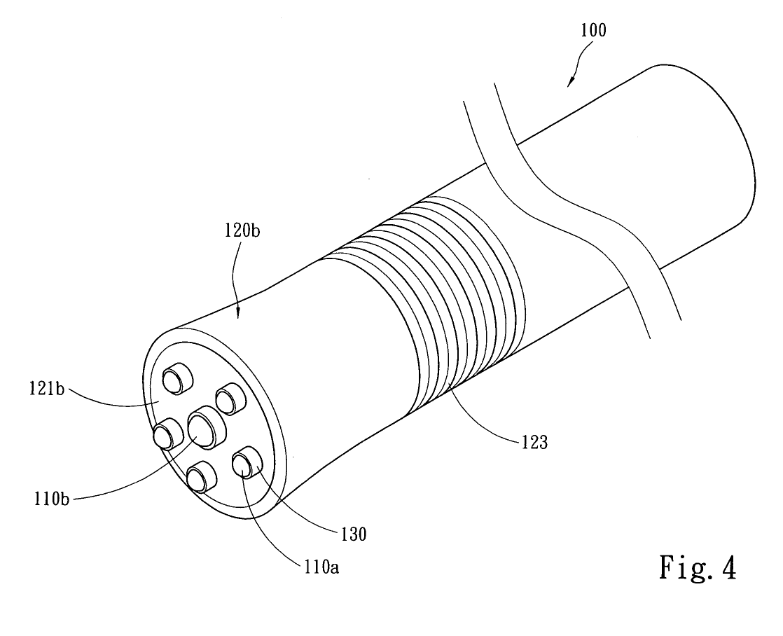

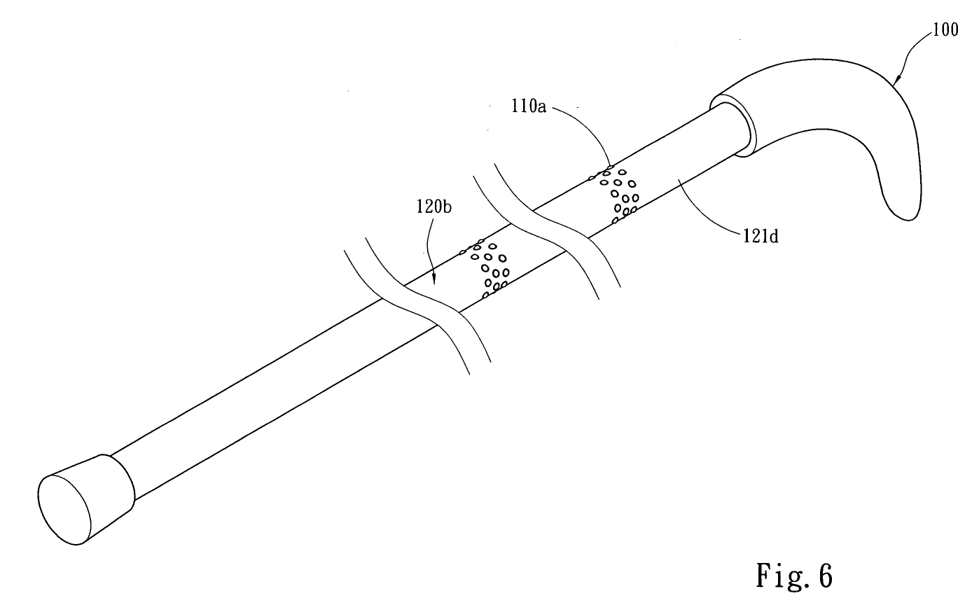

Refer to FIG. 4 a diagram schematically showing yet another embodiment of the present invention. According to this embodiment, the body is a column 120b with a slip-proof element 123. Each end of the column 120b has an accommodation surface 121b. The accommodation surface 121b has multiple balls 110a and 110b, which are of different sizes. As shown in FIG. 4, the ball 110b installed in the central portion of the accommodation surface 121b is larger than those installed in the perimeter of the accommodation surface 121b. Thus, those different-size balls 110a and 110b can provide different massage effects for the user. Further, the cylindrical surface of the column 120b may also function as an accommodation surface 121d, and multiple balls 110a are installed around the cylindrical accommodation surface 121d of the column 120b. Such an installation method of the balls 110a is also applied to the cane-like body shown in FIG. 6.

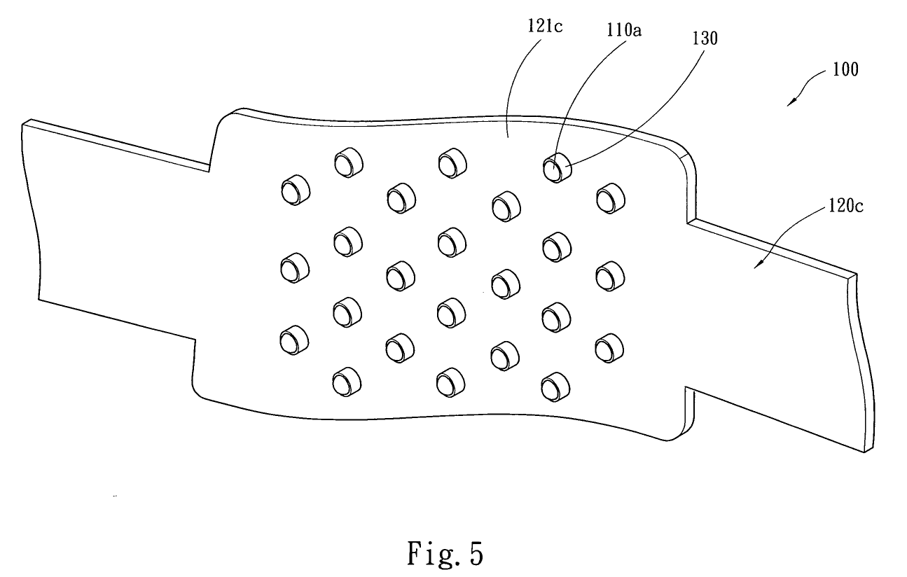

Refer to FIG. 5 a diagram schematically showing still another embodiment of the present invention. According to this embodiment, the body is a fabric 120c. The flexible fabric 120c can adapt to the contour of every part of the human body. Thus, when the user utilizes the portable ball-containing massage device 100 of this embodiment, he can obtain a large-area massage.

The present invention has been clarified with those preferred embodiment described above; however, it is not intended to limit the scope of the present invention. Any equivalent modification and variation according to the spirit of the present invention is to be also included within the scope the claims of the present invention.

What is claimed is:

1. A portable ball-containing massage device, comprising:
a body, being a one-piece part, and having an accommodation surface and multiple installing sockets disposed on said accommodation surface;
multiple retainers, respectively installed to said installing sockets, and each having an accommodation space; and
multiple balls, respectively embedded inside said accommodation spaces with a portion of the surface of said ball protruding outward from said accommodation space, confined to said accommodation space by said retainer, and driven to roll by a force.

2. The portable ball-containing massage device according to claim 1, wherein the material of said ball is a metal.

3. The portable ball-containing massage device according to claim 1, wherein the material of said ball is a magnet.

4. The portable ball-containing massage device according to claim 1, wherein the material of said ball is a stone.

5. The portable ball-containing massage device according to claim 1, wherein the material of said ball is a wood.

6. The portable ball-containing massage device according to claim 1, wherein the material of said ball is a plastic.

7. The portable ball-containing massage device according to claim 1, wherein said body is a base with a handle.

8. The portable ball-containing massage device according to claim 1, wherein said body is a column.

9. The portable ball-containing massage device according to claim 8, wherein said column has a slip-proof element.

10. The portable ball-containing massage device according to claim 1, wherein said body is a fabric.
